(19) United States
(12) Patent Application Publication
(10) Pub. No.: US 2009/0279874 A1
(43) Pub. Date: Nov. 12, 2009

(54) Recording device and driving state controlling method

(75) Inventors: Shunji Okada, Kanagawa (JP); Ryogo Ito, Tokyo (JP); Kenichiro Aridome, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/384,353

(22) Filed: Apr. 3, 2009

(30) Foreign Application Priority Data
Apr. 8, 2008 (JP) P2008-099887

(51) Int. Cl. H04N 5/00; G11B 20/00

(52) U.S. Cl. 386/126; 369/53.1; 386/E05.064; G9B/20

(57) ABSTRACT

A recording device including: a medium drive section configured to rotation-drive a disk recording medium, and write data to the disk recording medium through a head section; a determining section configured to determine whether the recording device is in a falling state when the medium drive section is in an idle state in which state the disk recording medium is rotation-driven and the head section is off a track; and a controlling section configured to make determination as to the falling state by the determining section when the determining section determines that the recording device is in the falling state, and when the determining section determines that the recording device is not in the falling state, controlling the medium drive section so as to set the medium drive section in an active state in which state the disk recording medium is rotation-driven to be in an accessible state and the head section is on track.

The present application claims priority from Japanese Patent Application No. JP 2008-099887, filed in the Japanese Patent Office on Apr. 8, 2008, the entire content of which is incorporated herein by reference.

### BACKGROUND OF THE INVENTION

1. Field of the Invention

The present invention relates to for example a recording device for recording data onto disk media such as a hard disk, an optical disk, a magneto-optical disk and the like, and a method of controlling a driving state of a recording drive used in the recording device.

2. Description of the Related Art

Recently, digital video cameras using a hard disk or a DVD (Digital Versatile Disk) as a recording medium have been provided. Some digital video cameras thus using a disk recording medium have a so-called automatic power-off function to avoid unnecessary battery consumption.

The automatic power-off function automatically turns off power to the digital video camera when the digital video camera has not been operated for a certain time while maintained in a power-on state. This certain time is generally set at about a few minutes. However, when the digital video camera is changed from the power-off state to the power-on state, it takes some time for the digital video camera using a disk recording medium to be able to write or read data with the disk recording medium rotation-driven at a proper rotational speed and with a recording and reproducing head (a magnetic head, an optical pickup or the like) correctly scanning a track on the disk recording medium.

Thus, the existing automatic power-off function changes a state of operation of a recording medium drive stepwise in order to reduce power consumption and minimize impairment of operability.

FIG. 6 is a diagram of assistance in explaining the automatic power-off function performed in a digital video camera including a hard disk drive. As shown in FIG. 6, when power is turned on to start the digital video camera at time point s, the digital video camera is controlled to be in an active state.

The active state refers to an on-track state in which a hard disk is rotation-driven at a proper rotational speed and a magnetic head is correctly scanning a track on the hard disk, and a state in which data can be written or read immediately. More specifically, the active state is a state in which each part forming the hard disk drive, such as an interface circuit (hereinafter referred to as an I/F circuit), a spindle motor, an actuator, a servo circuit, an RF (Radio Frequency) circuit, and the like, is operated.

The I/F circuit is a circuit part for transmitting and receiving data to and from a camera section. The spindle motor rotation-drives the hard disk. The actuator is to move the magnetic head in a radial direction of the hard disk. The servo circuit is to make it possible for the magnetic head to scan a track on the hard disk correctly. The RF circuit forms a recording signal to be supplied to the magnetic head, and forms a reproduced signal from a readout signal supplied from the magnetic head.

Then, as shown in FIG. 6, when time point a at which an elapsed time from time point s becomes a predetermined first time is reached without the digital video camera being operated by a user, the hard disk drive is controlled to be in an idle state. The idle state refers to a state in which the hard disk is rotation-driven and while the position of the magnetic head is maintained on the hard disk, the magnetic head is freed from control of the servo circuit and is off the track.

That is, in the idle state, the I/F circuit, the spindle motor, and the actuator described above are operated, and the servo circuit and the RF circuit are not operated. Therefore, in the case of the idle state, it is possible to return quickly to a state in which data can be written to the hard disk or data can be read from the hard disk by setting the servo circuit and the RF circuit operating.

Thus, as shown in FIG. 6, when the digital video camera is operated by the user at time point b, the hard disk drive is controlled to return to the active state quickly, so that data can be written to the hard disk or data can be read from the hard disk.

Incidentally, in the idle state, the magnetic head may be retained at a predetermined position outside the hard disk. In this case, the operation of the actuator can also be stopped, and therefore power consumption can be reduced more. However, it takes more time to return the hard disk drive to the active state than when the actuator is operated.

Then, as shown in FIG. 6, when time point c at which the elapsed time from time point s becomes a predetermined second time is reached without the digital video camera being operated after the hard disk drive is changed from the active state to the idle state at time point a, the hard disk drive is controlled to be in a power-off state.

The power-off state refers to a state in which all of the I/F circuit, the spindle motor, the actuator, the servo circuit, and the RF circuit described above are set in a nonoperating state. It is thereby possible to set the hard disk drive in the power-off state automatically, and thus reduce power consumption of the digital video camera.

FIG. 7 is a flowchart of assistance in explaining an example of control of a state of operation of the hard disk drive which control is performed in the digital video camera having the hard disk drive controlled as shown in FIG. 6. The process represented in FIG. 7 is performed when power to the digital video camera including the hard disk drive is turned on.

When the power to the digital video camera is turned on, the digital video camera first controls the hard disk drive so as to set the hard disk drive in the active state (step S101). Then, the digital video camera starts an elapsed time timer (step S102). Incidentally, when the elapsed time timer is started first, measurement is started after the elapsed time timer is reset.

The digital video camera is then ready to receive operation input from the user (step S103), and determines whether an operation input from the user has been received (step S104). When the digital video camera determines in the determination process of step S104 that an operation input from the user has been received, the digital video camera resets the elapsed time timer (step S105), and performs a process according to the operation input. The digital video camera then repeats the process from step S102.

When the digital video camera determines in the determination process of step S104 that no operation input has been received, the digital video camera determines whether the value of the elapsed time timer indicates the passage of a predetermined first time (step S106). When the digital video camera determines in the determination process of step S106 that the predetermined first time has not passed, the digital video camera repeats the process from step S103.

When the digital video camera determines in the determination process of step S106 that the first time has passed, the digital video camera controls the hard disk drive so as to set the hard disk drive in the idle state (step S107). The digital video camera is thereafter ready to receive operation input from the user (step S108), and determines whether an operation input from the user has been received (step S109). When the digital video camera determines in the determination process of step S109 that an operation input from the user has been received, the digital video camera resets the elapsed time timer (step S110), and performs a process according to the operation input. The digital video camera then repeats the process from step S101.

When the digital video camera determines in the determination process of step S109 that no operation input has been received, the digital video camera determines whether the value of the elapsed time timer indicates the passage of a predetermined second time (step S111). When the digital video camera determines in the determination process of step S111 that the predetermined second time has not passed, the digital video camera repeats the process from step S108.

When the digital video camera determines in the determination process of step Sill that the second time has passed, the digital video camera controls the hard disk drive and the digital video camera (system) so as to set the hard disk drive and the digital video camera in the power-off state (step S112). The digital video camera then ends the process shown in FIG. 7. When the power to the digital video camera is thereafter turned on, the process shown in FIG. 7 is performed.

Thus, the existing automatic power-off function changes the state of operation of the hard disk drive stepwise, thereby making it possible to reduce power consumption and perform a process according to an operation of the user with as little a delay as possible.

In the case of the existing automatic power-off function described with reference to FIG. 6 and FIG. 7, the hard disk drive is set in the idle state when the predetermined first time has passed. In order to make a transition from this idle state to the active state, an operation input from the user is required. However, it is more desirable to return to the active state as quickly as possible, and perform a process according to an operation input by the user immediately when the operation input is received.

As a method for addressing this problem, Japanese Patent Laid-Open No. 2006-86651 (hereinafter referred to as Patent Document 1) discloses an invention relating to an image pickup device that can avoid unnecessary power consumption without impairing operability. The invention described in Patent Document 1 has a first timer that measures a first time for setting a power-saving mode in which an EVF (electronic viewfinder) is off and a second timer that measures a second time for turning off power to a video camera.

When the first timer measures the passage of the first time, the EVF is turned off, and the power-saving mode is set. When a change in attitude or a vibration is thereafter detected without an operation input of the user being received, that is, when the user holds the video camera in a hand of the user, for example, the EVF is turned on to return to the original state. At this time, the first timer is reset, but the second timer is not reset.

When an operation input is thereafter received from the user, the EVF is already on, and therefore photographing can be resumed immediately. In a case where there is no operation input, because the second time is not reset, power to the video camera can be turned off to save power when the predetermined second time has passed.

Thus, the techniques described in Patent Document 1 make it possible to perform a process according to an operation input of the user as quickly as possible, and to reduce power consumption.

### SUMMARY OF THE INVENTION

In the case of the techniques described in the foregoing Patent Document 1, when a change in attitude or a vibration is detected, the power-saving mode is ended immediately to return to the original state. Thus, recording devices such for example as a video camera using a disk recording medium such as a hard disk, an optical disk or the like as a recording medium cannot adopt the techniques.

For example, consideration will be given to a case where a video camera including a hard disk driver is used, the video camera is then placed at a high position on a table, a shelf or the like to do something else, and the video camera falls due to some cause after a change is made from the active state to the idle state because the first time has passed.

In such a case, the invention described in the foregoing Patent Document 1 sets the hard disk drive in the active state in a stage where a change in attitude or a vibration is detected. When the video camera then falls and a great impact is applied to the video camera as the video camera collides with a floor, for example, the file system itself of the hard disk may be crashed as a result of a fatal writing operation error being caused to the file system of the hard disk, for example. In this case, the hard disk drive itself may be rendered unusable.

In addition, in the case of a recording device such as a video camera or the like using a disk recording medium, it is at a time when the disk drive is in the active state that it is desirable to be able to deal with an unexpected event such as a fall or the like. However, when priority is given to the protection of the disk drive not only in the case of a fall but also in a case where the attitude of the video camera is changed as a user holds the video camera in a hand of the user, for example, the active state of the disk drive cannot be maintained properly, thus impeding the quick performance of a process according to an operation of the user.

In view of the above, it is desirable to provide a recording device using a disk recording medium which device is not easily affected by an impact of a fall and does not impair the quickness of a process according to an operation of a user.

According to an embodiment of the present invention, there is provided a recording device including: a medium drive section configured to rotation-drive a disk recording medium, and at least writing data to the disk recording medium through a head section; a determining section configure to determine whether the recording device is in a falling state when the medium drive section is in an idle state in which state the disk recording medium is rotation-driven and the head section is off a track; and a controlling section configured to further make determination as to the falling state by the determining section when the determining section determines that the recording device is in the falling state, and when the determining section determines that the recording device is not in the falling state, controlling the medium drive section so as to set the medium drive section in an active state in which state the disk recording medium is rotation-driven to be in an accessible state and the head section is on track.

According to the recording device in accordance with the first embodiment of the present invention, when the determining section determines that the recording device is in the falling state while the medium drive section of the disk recording medium is in the idle state, the process of determining whether the recording device is in the falling state by the determining section is repeated. When the determining section determines that a change in acceleration has occurred in the recording device but the recording device is not in the falling state, the controlling section changes the medium drive section from the idle state to the active state.

Thus, in a case where the recording device is in the falling state when the medium drive section is in the idle state, the medium drive section can be returned to the active state after the falling state is ended. Therefore the recording device is not easily affected by an impact of the fall. In addition, after the fall is ended, or in a case of motion different from a fall at a time of a user holding the recording device in a hand of the user, for example, the medium drive section is quickly returned from the idle state to the active state. Therefore the quickness of a process according to an operation of a user is not impaired.

A recording device according to a second embodiment of the present invention is the recording device according to the first embodiment of the present invention, further including: an acceleration detecting section; and a state controlling section configured to control the medium drive section so as to set the medium drive section in the idle state when the acceleration detecting section detects that an acceleration has occurred in the recording device while the medium drive section is in the active state; wherein the determining section determines whether the recording device is in the falling state after the state controlling section changes the medium drive section from the active state to the idle state.

According to the second embodiment of the present invention, when the acceleration detecting section detects that an acceleration has occurred in the recording device while the medium drive section is in the active state, the state controlling section sets the medium drive section in the idle state. Thereafter the determining section determines whether the recording device is in the falling state. When the determining section determines that a change in acceleration has occurred in the recording device but the recording device is not in the falling state, the controlling section changes the medium drive section from the idle state to the active state.

Thus, when a change in acceleration occurs in the recording device while the medium drive section is in the active state, the medium drive section is quickly changed to the idle state. Thereby the disk medium can be protected. Thereafter, when the change in acceleration which change has occurred in the recording device is not caused by a fall, or when a falling state is ended, it is determined that the recording device is not in the falling state, and the medium drive section is quickly changed to the active state. Therefore the quickness of a process according to an operation of the user is not impaired.

A recording device according to a third embodiment of the present invention is the recording device according to the first embodiment of the present invention, further including: a counter section configured to measure an elapsed time from a time point at which the medium drive section is set in the active state; an acceleration detecting section; and a state controlling section configured to control the medium drive section so as to set the medium drive section in the idle state when no operation input is received from a user before a count value of the counter section becomes a predetermined value after the medium drive section is set in the active state; wherein the determining section determines whether the recording device is in the falling state when the acceleration detecting section detects that an acceleration has occurred in the recording device after the state controlling section changes the medium drive section from the active state to the idle state.

According to the third embodiment of the present invention, an elapsed time from a time point at which the medium drive section is set in the active state is measured by the counter section. When no operation input is received from a user for a period before a result of the measurement by the counter section becomes a predetermined value, the state controlling section sets the medium drive section in the idle state.

When the acceleration detecting section detects that an acceleration has occurred in the recording device after the medium drive section is set in the idle state, the determining section determines whether the recording device is in the falling state. When the determining section determines that the recording device is in the falling state, the determining process of the determining section is repeated. When the determining section determines that a change in acceleration has occurred in the recording device but the recording device is not in the falling state, the controlling section changes the medium drive section from the idle state to the active state.

Thus, when a change in acceleration occurs in the recording device after the medium drive section is set in the idle state by a so-called automatic power-off function, and it is determined that the recording device is in the falling state, the determining process of the determining section is repeated, and the idle state of the medium drive section is maintained. Therefore the disk medium can be protected. Thereafter, when the change in acceleration which change has occurred in the recording device is not caused by a fall, or when a falling state is ended, it is determined that the recording device is not in the falling state, and the medium drive section is quickly changed to the active state. Therefore the quickness of a process according to an operation of the user is not impaired.

According to the preferred embodiments of the present invention, in a recording device using a disk recording medium, resistance to an impact of a fall can be improved. In addition, in a recording device using a disk recording medium, impairment of quickness of a process according to an operation of a user can be prevented.

### BRIEF DESCRIPTION OF THE DRAWINGS

FIG. 1 is a block diagram of assistance in explaining an image pickup device to which an embodiment of the present invention is applied;

FIG. 2 is a diagram of assistance in explaining control of a state of an HDD (Hard Disc Drive);

FIG. 3 is a flowchart of assistance in explaining a concrete process for controlling the state of operation of the HDD which process is performed in the image pickup device shown in FIG. 1;

FIG. 4 is a flowchart continued from FIG. 3;

FIGS. 5A, 5B, and 5C are diagrams of assistance in explaining an example of a fall determination process;

FIG. 6 is a diagram of assistance in explaining an existing example of an automatic power-off function performed in a digital video camera including a hard disk drive; and

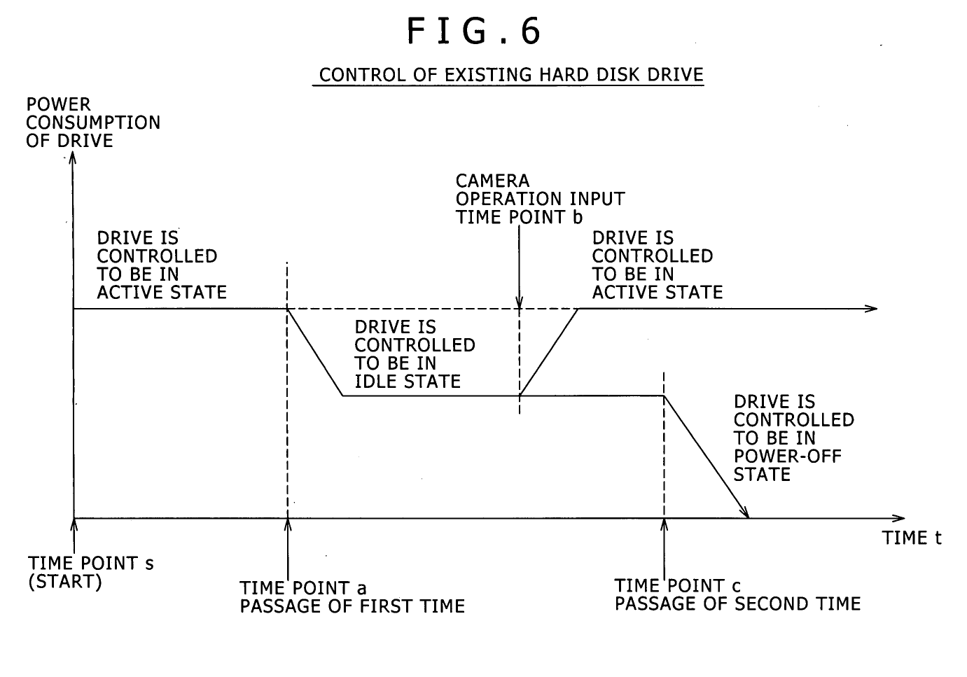

FIG. 7 is a flowchart of assistance in explaining an existing example of controlling a state of operation of the hard disk drive by the automatic power-off function.

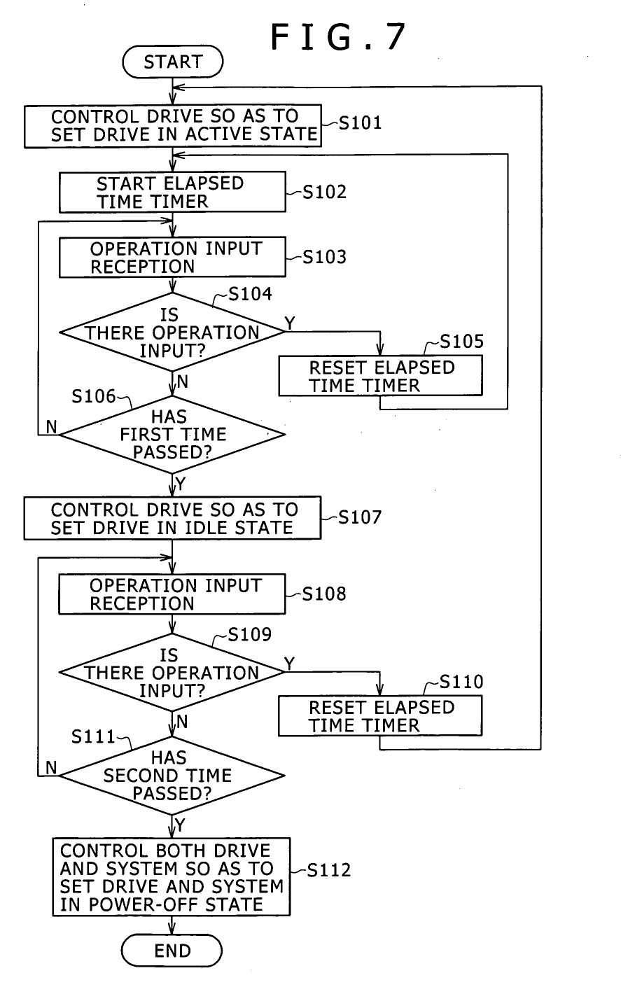

### DETAILED DESCRIPTION OF THE PREFERRED EMBODIMENTS

Embodiments of the present invention will hereinafter be described with reference to the drawings. Description will be made below by taking as an example a case where an embodiment of the present invention is applied to a digital video camera (hereinafter referred to as an image pickup device) using a hard disk as a recording medium.

### [Example of Configuration of Image Pickup Device]

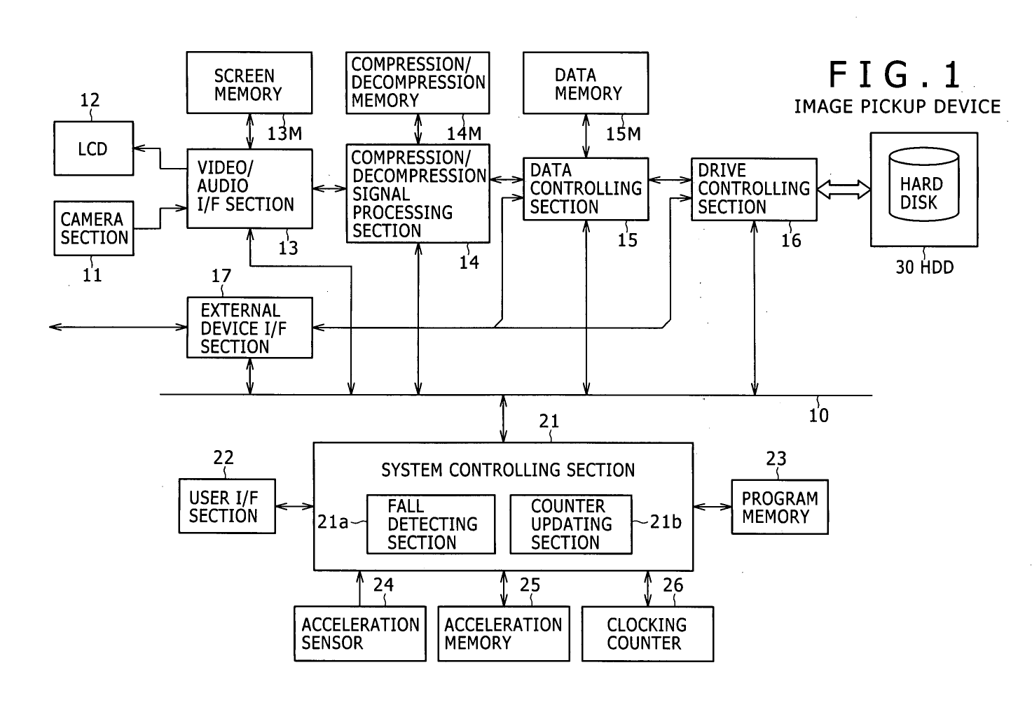

FIG. 1 is a block diagram of assistance in explaining an image pickup device according to the present embodiment. As shown in FIG. 1, the image pickup device according to the present embodiment includes a camera section 11, a color LCD (Liquid Crystal Display) 12, a video/audio interface section (hereinafter referred to as a video/audio I/F section) 13, a compression/decompression signal processing section 14, a data controlling section 15, a drive controlling section 16, an external device interface section (hereinafter referred to as an external device I/F section) 17, a system controlling section 21, a user interface section (hereinafter referred to as a user I/F section) 22, a program memory 23, an acceleration sensor 24, an acceleration memory 25, a clocking counter 26, and an HDD (Hard Disc Drive) 30.

As shown in FIG. 1, the video/audio I/F section 13, the compression/decompression signal processing section 14, and the data controlling section 15 are respectively provided with a screen memory 13M, a compression/decompression memory 14M, and a data memory 15M used mainly as a work area.

The HDD 30 is built in the image pickup device according to the present embodiment, and includes a hard disk as a disk recording medium having a storage capacity of a few hundred gigabytes or more, for example. Though not shown, the HDD 30 further includes for example an I/F circuit that sends and receives data and which has a function of controlling various parts of the HDD 30, a spindle motor for rotation-driving the hard disk, a magnetic head, an actuator for controlling the position of the magnetic head in a radial direction on the hard disk, a servo circuit for enabling the magnetic head to scan accurately on a track of the hard disk, and an RF circuit for generating a recording signal to be supplied to the magnetic head and generating a reproduced signal from a signal from the magnetic head.

As will be described below, the HDD 30 can record data supplied thereto onto the built-in hard disk, and read data recorded on the built-in hard disk and then supply the data to a predetermined circuit section. In addition, the HDD 30 can be controlled to be set in at least three states, that is, an active state, an idle state, and a power-off state.

In this case, as described above, the active state is an on-track state in which the hard disk of the HDD 30 is rotation-driven at a proper rotational speed and the magnetic head accurately scans a track on the hard disk, and is a state in which data can be written or read instantly.

The idle state refers to a state in which the hard disk of the HDD 30 is rotation-driven and while the position of the magnetic head is maintained on the hard disk, the magnetic head is freed from control of the servo circuit and is off the track. The power-off state refers to a state in which supply of power to each circuit section of the HDD 30 is stopped and each circuit section is set in a nonoperating state.

The system controlling section 21 in the image pickup device according to the present embodiment controls various parts of the image pickup device according to the present embodiment. Though not shown, the system controlling section 21 is a microcomputer formed by connecting a CPU (Central Processing Unit), a RAM (Random Access Memory) used as a work area, and a nonvolatile memory such as an EEPROM (Electrically Erasable and Programmable Read Only Memory), a flash memory or the like for storing and retaining a setting parameter and various other data to be retained even after power is turned off to each other via a CPU bus.

As shown in FIG. 1, the system controlling section 21 is connected with the user I/F section 22, the program memory 23, the acceleration sensor 24, the acceleration memory 25, and the clocking counter 26. The user I/F section 22 is composed of a plurality of function keys, a button switch, a sliding key and the like. The user I/F section 22 can receive various instruction inputs for starting photographing, ending photographing, starting reproduction, ending reproduction and the like from a user, and notify the instruction inputs to the system controlling section 21. Thus, the system controlling section 21 controls various parts according to an instruction input from the user, whereby the image pickup device can perform a process according to the instruction of the user.

Various programs to be executed in the system controlling section 21 and data necessary for processing are recorded in the program memory 23.

The acceleration sensor 24 is a triaxial acceleration sensor. The acceleration sensor 24 detects acceleration occurring in the image pickup device according to the present embodiment at relatively short intervals of about 10 msec (10 milliseconds), for example, and notifies the result to the system controlling section 21. With this function of the acceleration sensor 24, it is possible to detect occurrence of acceleration in the image pickup device according to the present embodiment when the image pickup device is held in a hand of a user or the image pickup device falls, for example. Thus, when the acceleration sensor 24 detects an acceleration at a fixed value or more, for example, it can be determined that the image pickup device is in a moving state (a state of being moved).

The acceleration memory 25 stores and retains history information on acceleration such as information indicating the acceleration detected by the acceleration sensor 24, which information is sequentially supplied through the system controlling section 21, and a synthetic value formed in the system controlling section 21 on the basis of the information indicating the acceleration from the acceleration sensor 24. In this case, the synthetic value formed in the system controlling section 21 on the basis of the information indicating the acceleration is information indicating gravitational acceleration applied to the image pickup device according to the present embodiment, and is a value calculated as a sum of squares of acceleration values corresponding to three orthogonal axes of an X-axis, a Y-axis, and a Z-axis, for example.

As will be described later in detail, the system controlling section 21 in the present embodiment can implement a function of determining section configured to determine whether the image pickup device is in a falling state on the basis of the acceleration (information indicating the acceleration) detected by the acceleration sensor 24 and the history information on acceleration (the information indicating the acceleration and the synthetic value of the acceleration) which history information is stored and retained in the acceleration memory 25. That is, the system controlling section 21 also implements a function of a fall detecting section 21a.

The clocking counter 26 can measure various periods according to control of the system controlling section 21. Specifically, in order to implement a so-called automatic power-off function, the clocking counter 26 can measure a time from a point in time at which the hard disk drive (hereinafter abbreviated to the HDD) 30 to be described later is set in an active state. In addition, the clocking counter 26 can be cleared in necessary timing by control of the system controlling section 21. Thus, the system controlling section 21 also implements a function of a counter updating section 21b that controls the clocking counter 26.

As shown in FIG. 1, the camera section 11 and the color LCD 12 are connected to the video/audio I/F section 13. The camera section 11 has a lens and an image pickup element such as a CCD (Charge Coupled Device) or a CMOS (Complementary Metal Oxide Semiconductor) image sensor or the like. The camera section 11 converts an image of a subject which image has passed through the lens into an analog video signal by the image pickup element, and then supplies the analog video signal to a circuit section in a succeeding stage. In addition, a microphone not shown in the figure is provided in the vicinity of the camera section 11 so that sound can be collected at a time of photographing and the collected sound can be converted into an electric signal and then captured.

The color LCD 12 makes color display of video data on a subject which data is captured through the camera section 11 and a reproduced image based on video data read from the hard disk of the HDD 30 to be described later or the like. In addition, for example, a speaker not shown in the figure is provided in the vicinity of the color LCD 12 so as to be able to emit reproduced sound based on audio data of sound collected by the microphone or audio data read from the hard disk of the HDD 30.

The video/audio I/F section 13 receives the analog video signal from the camera section 11 and the analog audio signal from the microphone, converts these signals into digital signals in such a format as to be processible in the image pickup device, and then supplies the video data and the audio data after the conversion to the compression/decompression signal processing section 14 in the following stage. The video/audio I/F section 13 thus has a function of capturing the video signal from the camera section 11 and the audio signal into the image pickup device.

In addition, the video/audio I/F section 13 converts video data and audio data resulting from decompression processing from the compression/decompression signal processing section 14 into analog signals, and then supplies the analog video signal to the color LCD 12 and supplies the analog audio signal to the speaker. The video/audio I/F section 13 thus has functions of capturing video data and audio data into the image pickup device and reproducing video and audio in the image pickup device.

The compression/decompression signal processing section 14 subjects video data and audio data from the video/audio I/F section 13 to data compression by a predetermined system, and then supplies the video data and the audio data after the data compression to the data controlling section 15 in the following stage. In addition, the compression/decompression signal processing section 14 decompresses data-compressed video data and audio data from the data controlling section 15, and then supplies the video data and the audio data after the data decompression to the video/audio I/F section 13.

Incidentally, data compression systems used in the compression/decompression signal processing section 14 are for example JPEG (Joint Photographic Experts Group), MPEG (Moving Picture Experts Group), and alternative systems in the future having developed functions of JPEG and MPEG in the case of still images and MPEG2 and alternative systems in the future having developed functions of MPEG2 in the case of moving images. Of course, the data compression systems are not limited to these systems, but various systems can be used.

The data controlling section 15 uses the data memory 15M formed by an SDRAM (Synchronous Dynamic RAM) or the like as a buffer memory, and makes a time-base correction for video data and audio data between the asynchronous image pickup device and the hard disk of the HDD 30 included in the image pickup device.

Therefore, when video data and audio data obtained through the camera section 11 is to be recorded onto the hard disk of the HDD 30, the data from the compression/decompression signal processing section 14 is recorded in the data memory 15M via the data controlling section 15, and data previously recorded in the data memory 15M is read by the data controlling section 15 and then supplied to the drive controlling section 16 to be recorded onto the hard disk of the HDD 30, as will be described later.

In addition, video data and audio data read from the hard disk of the HDD 30, which data is supplied through the drive controlling section 16, is recorded in the data memory 15M via the data controlling section 15, and data previously recorded in the data memory 15M is read by the data controlling section 15 and then supplied to the compression/decompression signal processing section 14 to be subjected to data decompression and digital/analog conversion and then output, as described above.

Thus, the data memory 15M is used in a so-called first-in first-out format. The data memory 15M for example allows temporally continuous video data and audio data supplied from the camera section 11 to be recorded onto the hard disk of the HDD 30 without interruption and allows temporally continuous video data and audio data recorded on the hard disk of the HDD 30 to be reproduced without interruption.

The drive controlling section 16 is a connection interface with the HDD 30. According to control from the system controlling section 21, the drive controlling section 16 can supply data from the data controlling section 15 to the HDD 30 to record the data onto the hard disk, and can be supplied with desired data from the HDD 30 after the data is read from the hard disk and then supply the data to the data controlling section 15.

The drive controlling section 16 can perform for example control to change a state of operation of the HDD 30 by supplying a command corresponding to control from the system controlling section 21 to the HDD 30. That is, the drive controlling section 16 can change the state of operation such as an active state, an idle state, a power-off state or the like.

The image pickup device according to the present embodiment also has the external device I/F section 17. The external device I/F section 17 for example enables connection to an external device such as a personal computer or the like. The external device I/F section 17 is for example a digital interface circuit such as a USB (Universal Serial Bus) circuit or the like. When the external device I/F section 17 is used, data can be exchanged through the data controlling section 15 and the drive controlling section 16 or through the drive controlling section 16.

Thus, the image pickup device according to the present embodiment can supply video data and audio data captured through the camera section 11 to the HDD 30 via the video/audio I/F section 13, the compression/decompression signal processing section 14, the data controlling section 15, and the drive controlling section 16, and record the video data and the audio data onto the hard disk of the HDD 30.

In addition, in the image pickup device according to the present embodiment, the drive controlling section 16 controls the HDD 30 to read video data and audio data from the hard disk of the HDD 30, supply the video data and the audio data to the color LCD 12 through the drive controlling section 16, the data controlling section 15, the compression/decompression signal processing section 14, and the video/audio I/F section 13, and reproduce and output video according to the video data read from the hard disk of the HDD 30 and audio according to the audio data through the color LCD 12 and the speaker not shown in the figure.

In addition, the image pickup device according to the present embodiment can be supplied with data from the personal computer connected through the external device I/F section 17, supply the data to the HDD 30 through the data controlling section 15 and the drive controlling section 16 or through the drive controlling section 16, and record the data onto the hard disk included in the HDD 30.

The image pickup device according to the present embodiment can also supply data read from the hard disk of the HDD 30 by the drive controlling section 16 to the external device through the drive controlling section 16 and the external device I/F section 17 or through the drive controlling section 16, the data controlling section 15, and the external device I/F section 17.

### [Control of State of Operation of HDD 30]

The image pickup device according to the present embodiment includes the HDD 30 using a hard disk as a recording medium, and has a so-called automatic power-off function from a viewpoint of reducing power consumption. In addition to the automatic power-off function, the image pickup device according to the present embodiment takes information on acceleration occurring in the image pickup device into account. The image pickup device thereby properly protects the hard disk of the HDD 30 from a fall of the image pickup device or the like, and does not impair the quickness of a process so that the process corresponding to an operation of a user can be performed quickly.

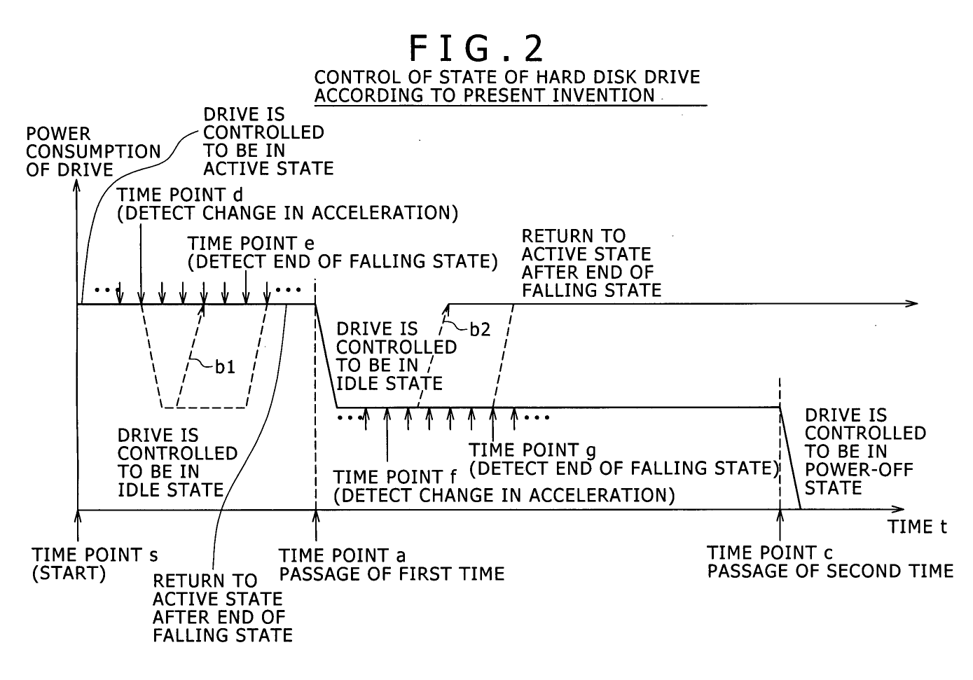

FIG. 2 is a diagram of assistance in explaining control of the state of the HDD 30 in the image pickup device according to the present embodiment. As shown in FIG. 2, when power is turned on to start the image pickup device according to the present embodiment at time point s, the image pickup device according to the present embodiment resets the clocking counter 26 and makes the clocking counter 26 start clocking time (counting time), and sets the HDD 30 in an active state.

At this time, the system controlling section 21 detects acceleration through the acceleration sensor 24 at relatively short intervals. Solid-line arrows other than arrows indicating time point s, time point a, and time point c in FIG. 2 indicate timing of detection of acceleration. The acceleration sensor 24 notifies a result of detection to the system controlling section 21, so that when a change in acceleration occurs in the image pickup device, the system controlling section 21 can be quickly informed of the change.

In addition, as described above, the system controlling section 21 supplies the detection result from the acceleration sensor 24 and a synthetic value of the detection result from the acceleration sensor 24 to the acceleration memory 25 to store and retain the detection result and the synthetic value in the acceleration memory 25.

Then, after time point s, when there is no operation input to the image pickup device by a user and no change in acceleration occurs in the image pickup device while the HDD 30 is in the active state, the HDD 30 is set in an idle state in which power consumption is lower than in the active state at time point a at which the value of the clocking counter 26 indicates the passage of a predetermined first time.

Thereafter, when there is no operation input to the image pickup device by a user and no change in acceleration occurs in the image pickup device while the HDD 30 is in the idle state, the HDD 30 is set in a power-off state in which power consumption is even lower than in the idle state at time point c at which the value of the clocking counter 26 indicates the passage of a predetermined second time.

Thus, the image pickup device according to the present embodiment controls the state of the HDD 30 by the existing automatic power-off function to prevent unnecessary power consumption.

However, as shown in FIG. 2, suppose that the acceleration sensor 24 detects a change in acceleration in the image pickup device at time point d at which the HDD 30 is in the active state. In this case, the system controlling section 21 in the image pickup device controls the drive controlling section 16 to set the HDD 30 in the idle state and thereby protect the hard disk of the HDD 30.

Further, the system controlling section 21 determines whether the image pickup device is in a falling state from detection output from the acceleration sensor 24 and a history of changes in acceleration which history is stored and retained in the acceleration memory 25. For example, when it is determined that the image pickup device is in a state of operation different from falling because the image pickup device is held in a hand of a user, for example, or when it is determined that the image pickup device is no longer in a falling state, there is a strong possibility that some operation, such for example as an operation of a photographing start button by the user, will be performed next.

Accordingly, in this case, as indicated by a dotted-line arrow b1 in FIG. 2, the system controlling section 21 controls the HDD 30 through the drive controlling section 16 to return the HDD 30 to the active state quickly. At this time, the system controlling section 21 resets the clocking counter 26 for the automatic power-off function and makes the clocking counter 26 start a new clocking process. This makes it possible to respond quickly to a subsequent operation from the user.

When the system controlling section 21 determines that the image pickup device is in a falling state after time point d, however, the system controlling section 21 further repeats the determination of whether the image pickup device is in a falling state. Then, when the system controlling section 21 can determine that the falling state is ended, the system controlling section 21 returns the HDD 30 to the active state. In the example shown in FIG. 2, the system controlling section 21 determines (detects) that the falling state is ended at time point e, and controls the HDD 30 through the drive controlling section 16 to return the HDD 30 to the active state. In addition, at this time, the system controlling section 21 resets the clocking counter 26 for the automatic power-off function and makes the clocking counter 26 start a new clocking process. This makes it possible to surely protect the hard disk of the HDD 30.

Then, as shown in FIG. 2, the system controlling section 21 monitors detection output from the acceleration sensor 24 even after the HDD 30 is changed from the active state to the idle state by the automatic power-off function. Then, as shown in FIG. 2, suppose that the acceleration sensor 24 detects a change in acceleration in the image pickup device at time point f at which the HDD 30 is in the idle state.

In this case, the HDD 30 is already in the idle state, and therefore the system controlling section 21 determines whether the image pickup device is in a falling state from the detection output from the acceleration sensor 24 and the history of changes in acceleration (information indicating acceleration and synthetic values of acceleration) which history is stored and retained in the acceleration memory 25. In this case, for example, when it is determined that the image pickup device is in a state of operation different from falling because the image pickup device is held in a hand of the user, for example, or when it is determined that the image pickup device is no longer in a falling state, there is a strong possibility that some operation, such for example as an operation of a photographing start button by the user, will be performed next.

Accordingly, in this case, as indicated by a dotted-line arrow b2 in FIG. 2, the system controlling section 21 controls the HDD 30 through the drive controlling section 16 to return the HDD 30 to the active state quickly. At this time, the system controlling section 21 resets the clocking counter 26 for the automatic power-off function and makes the clocking counter 26 start a new clocking process. This makes it possible to respond quickly to a subsequent operation from the user.

When the system controlling section 21 determines that the image pickup device is in a falling state after time point f, however, the system controlling section 21 further repeats the determination of whether the image pickup device is in a falling state. Then, when the system controlling section 21 can determine that the falling state is ended, the system controlling section 21 returns the HDD 30 to the active state. In the example shown in FIG. 2, the system controlling section 21 determines (detects) that the falling state is ended at time point g, and controls the HDD 30 through the drive controlling section 16 to return the HDD 30 to the active state. In addition, at this time, the system controlling section 21 resets the clocking counter 26 for the automatic power-off function. This makes it possible to surely protect the hard disk of the HDD 30.

Thus, in the image pickup device according to the present embodiment, when the HDD 30 is in the idle state and a change in acceleration occurs in the image pickup device according to the present embodiment due to some cause, whether the image pickup device is in a falling state is determined first. When it is determined that the image pickup device is not falling, or when it is determined that the image pickup device is no longer in a falling state, the HDD 30 is quickly returned to the active state, so that the image pickup device can be quickly restored to a state of being able to perform a process according to an operation of the user.

In addition, when it is determined that the image pickup device is in a falling state, the system controlling section 21 maintains the idle state of the HDD 30 until the falling state is ended. Therefore the hard disk of the HDD 30 can be protected properly from an impact when the image pickup device actually falls.

### [Concrete Process for Controlling State of Operation of HDD 30]

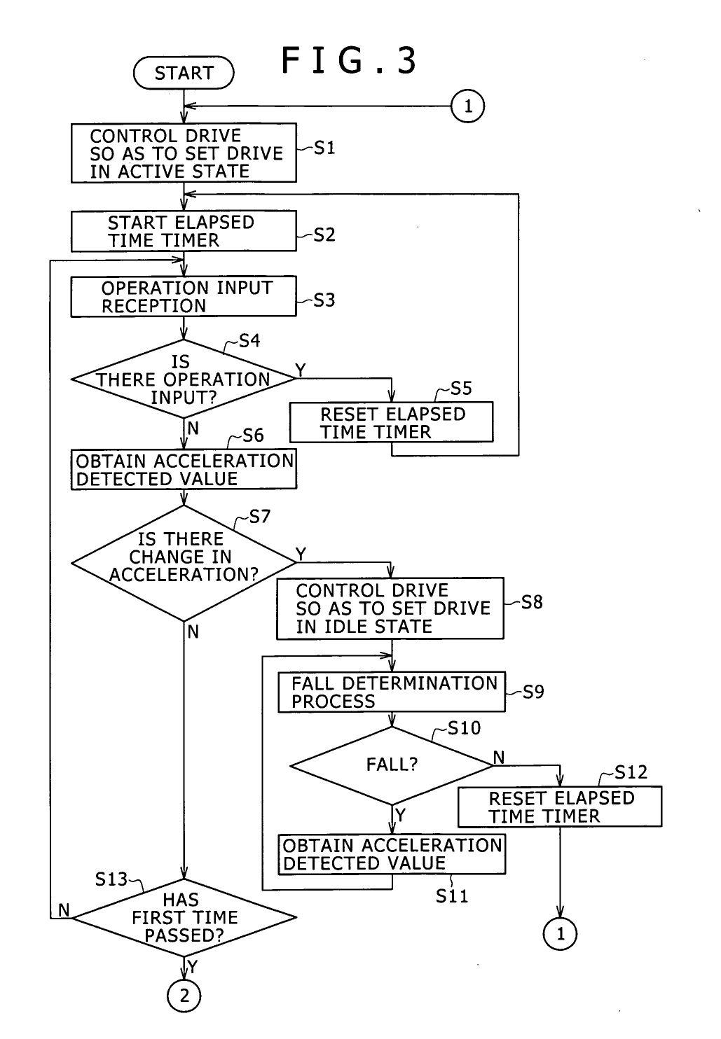

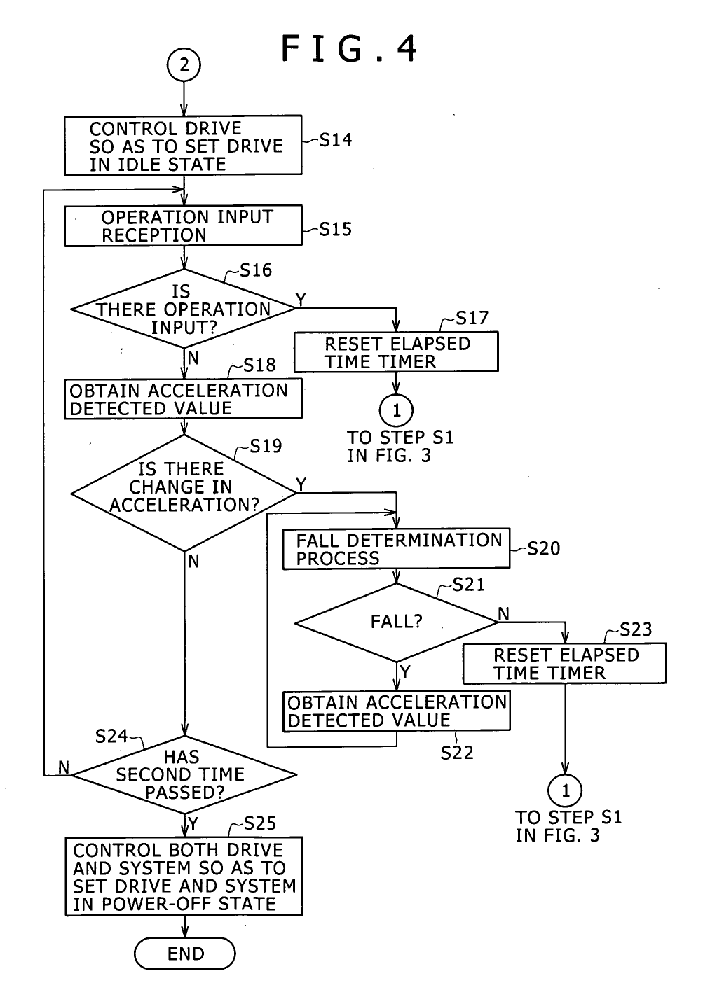

Description will next be made of a concrete process for controlling a state of operation of the HDD 30 which process is performed in the image pickup device according to the present embodiment. FIG. 3 and FIG. 4 are flowcharts of assistance in explaining a concrete process for controlling a state of operation of the HDD 30 which process is performed in the image pickup device according to the present embodiment. The process shown in FIG. 3 and FIG. 4 is performed mainly by the system controlling section 21 after power to the image pickup device according to the present embodiment is turned on.

When power to the image pickup device according to the present embodiment is turned on, the system controlling section 21 in the image pickup device controls the HDD 30 through the drive controlling section 16 to set the HDD 30 in the active state (step S1). The system controlling section 21 then controls the clocking counter 26 to make the clocking counter 26 start a time counting process (step S2).

A count value obtained by counting elapsed time which counting is started in this step S2 is used to change the state of operation of the HDD 30 according to the automatic power-off function. In addition, the image pickup device according to the present embodiment for example resets the clocking counter at the time of turning on power, so that the counting of elapsed time can be started quickly.

The system controlling section 21 is thereafter ready to receive operation input from the user through the user I/F section 22 (step S3), and determines whether an operation input has been received (step S4). When the system controlling section 21 determines in step S4 that an operation input from the user has been received, the system controlling section 21 performs a process according to the operation input, and resets the clocking counter 26 (step S5). The system controlling section 21 then repeats the process from step S2.

When the system controlling section 21 determines in the determination process of step S4 that no operation input has been received, the system controlling section 21 obtains detection output from the acceleration sensor 24 (step S6), and determines whether a change in acceleration has occurred in the image pickup device (step S7). As described above, the acceleration sensor 24 detects acceleration in each predetermined timing. The system controlling section 21 can determine whether a change in acceleration has occurred by referring to the detection output.

When the system controlling section 21 determines in step S7 that a change in acceleration has occurred, there is a possibility of the image pickup device being in a falling state. The system controlling section 21 therefore controls the HDD 30 through the drive controlling section 16 to set the HDD 30 in the idle state (step S8). The system controlling section 21 thereafter performs a fall determination process for determining whether the image pickup device is in a falling state from the detection output from the acceleration sensor 24 and history information on acceleration (acceleration and synthetic values of acceleration) which history information is stored and retained in the acceleration memory 25 (step S9).

Though details of the fall determination process in step S9 will be described later, an outline thereof is as follows. First, (1) whether the image pickup device is in a state of weightlessness is determined on the basis of a synthetic value of acceleration detected this time, and when the image pickup device is in a state of weightlessness, (2) whether a greater force than a predetermined threshold value was applied in the past when the user lifted the image pickup device, for example, is determined on the basis of past synthetic values of acceleration. When the greater force was not applied in the past, (3) whether a time of transition to the state of weightlessness is shorter than a predetermined threshold value is determined, and when the time of transition to the state of weightlessness is shorter than the predetermined threshold value, it is determined that the image pickup device is in a falling state. Otherwise, it is determined that the image pickup device is not in a falling state, or it is determined that the image pickup device is no longer in a falling state.

Then, the system controlling section 21 determines whether a result of the fall determination process in step S9 indicates a fall (step S10). When the system controlling section 21 determines in the determination process of step S10 that the image pickup device is in a falling state, the system controlling section 21 obtains a new acceleration from the acceleration sensor 24 (step S11), and then repeats the process from step S9. That is, the loop process from step S9 to step S11 is repeated until the image pickup device goes out of the falling state (until the falling state is ended).

When the determination process of step S10 indicates that the image pickup device is not in a falling state (when the image pickup device has not originally been in a falling state or when the image pickup device is no longer in a falling state), the system controlling section 21 resets the clocking counter 26 (step S12), and then repeats the process from step S1. That is, the image pickup device has not originally been in a falling state, or the image pickup device was in a falling state but the falling state is ended, and therefore the HDD 30 is returned from the idle state to the active state so that instruction input from the user can be received.

By the process of steps S7 to S12, when the HDD 30 is in the active state and a change in acceleration occurs in the image pickup device, the HDD 30 is first set in the idle state to protect the hard disk of the HDD 30. Then, the idle state is maintained until the falling state is ended, so that the hard disk of the HDD 30 can be surely protected. However, when the image pickup device has not originally been in a falling state as in a case of the image pickup device being lifted by the user, for example, or when the image pickup device was in a falling state but the falling state is ended, the HDD 30 is quickly returned from the idle state to the original active state so that a process in response to an operation input from the user, for example a photographing start process or the like can be performed quickly.

When the system controlling section 21 determines in the determination process of step S7 that no change in acceleration has occurred in the image pickup device, the system controlling section 21 determines whether the count value of the clocking counter started in step S2 indicates the passage of a predetermined “first time” as a reference for timing of changing from the active state to the idle state by the automatic power-off function (step S13).

When the system controlling section 21 determines in the determination process of step S13 that the “first time” has not passed yet, the system controlling section 21 repeats the process from step S3. In this case, the active state of the HDD 30 is maintained, and the process of receiving operation input from the user can be repeated while the clocking counter 26 continues the counting process.

When the system controlling section 21 determines in the determination process of step S13 that the “first time” has passed, the system controlling section 21 proceeds to the process shown in FIG. 4, and controls the HDD 30 through the drive controlling section 16 to set the HDD 30 in the idle state (step S14).

The system controlling section 21 is thereafter ready to receive operation input from the user through the user I/F section 22 (step S15), and determines whether an operation input has been received (step S16). When the system controlling section 21 determines in step S16 that an operation input from the user has been received, the system controlling section 21 performs a process according to the operation input, and resets the clocking counter 26 (step S17). The system controlling section 21 then repeats the process from step S1 shown in FIG. 3. The process from step S1 is thus performed because the HDD 30 is set in the idle state by the process of step S14 and thus needs to be returned to the active state.

When the system controlling section 21 determines in the determination process of step S16 that no operation input has been received, the system controlling section 21 obtains detection output from the acceleration sensor 24 (step S18), and determines whether a change in acceleration has occurred in the image pickup device (step S19). As described above, the acceleration sensor 24 detects acceleration in each predetermined timing. The system controlling section 21 can determine whether a change in acceleration has occurred by referring to the detection output.

When the system controlling section 21 determines in step S19 that a change in acceleration has occurred, because the HDD 30 is already in the idle state, the system controlling section 21 performs a fall determination process for determining whether the image pickup device is in a falling state from the detection output from the acceleration sensor 24 and the history information on acceleration (acceleration and synthetic values of acceleration) which history information is stored and retained in the acceleration memory 25 (step S20). The fall determination process in step S20 is performed in a similar manner to the process of step S9 shown in FIG. 3.

Then, the system controlling section 21 determines whether a result of the fall determination process in step S20 indicates a fall (step S21). When the system controlling section 21 determines in the determination process of step S21 that the image pickup device is in a falling state, the system controlling section 21 obtains a new acceleration from the acceleration sensor 24 (step S22), and then repeats the process from step S20. That is, the loop process from step S20 to step S22 is repeated until the image pickup device goes out of the falling state (until the falling state is ended).

When the determination process of step S21 indicates that the image pickup device is not in a falling state (when the image pickup device has not originally been in a falling state or when the image pickup device is no longer in a falling state), the system controlling section 21 resets the clocking counter 26 (step S23), and then repeats the process from step S1. That is, the image pickup device has not originally been in a falling state, or the image pickup device was in a falling state but the falling state is ended, and therefore the HDD 30 is returned from the idle state to the active state so that instruction input from the user can be received.

By the process of steps S19 to S23, when a change in acceleration occurs in the image pickup device after the HDD 30 is set in the idle state by the automatic power-off function, whether the image pickup device is falling is determined. Then, the idle state is maintained until the falling state is ended, so that the hard disk of the HDD 30 can be surely protected. However, when the image pickup device has not originally been in a falling state as in a case of the image pickup device being lifted by the user, for example, or when the image pickup device was in a falling state but the falling state is ended, the HDD 30 is quickly returned from the idle state to the active state so that a process in response to an operation input from the user, for example a photographing start process or the like can be performed quickly.

When the system controlling section 21 determines in the determination process of step S19 that no change in acceleration has occurred in the image pickup device, the system controlling section 21 determines whether the count value of the clocking counter started in step S2 indicates the passage of a predetermined “second time” as a reference for timing of changing from the idle state to the power-off state by the automatic power-off function (step S24).

When the system controlling section 21 determines in the determination process of step S24 that the “second time” has not passed yet, the system controlling section 21 repeats the process from step S15. In this case, the idle state of the HDD 30 is maintained, and the process of receiving operation input from the user can be repeated while the clocking counter 26 continues the counting process.

When the system controlling section 21 determines in the determination process of step S24 that the “second time” has passed, the system controlling section 21 sets both the HDD 30 and the system including the system controlling section 21 itself in the power-off state (step S25), and then ends the process shown in FIG. 3 and FIG. 4.

Thus, the image pickup device according to the present embodiment has the automatic power-off function, and monitors for a change in acceleration in the image pickup device while the HDD 30 is in the active state. When a change in acceleration has occurred in the image pickup device, the image pickup device first sets the HDD 30 in the idle state to protect the hard disk. The image pickup device thereafter determines whether the image pickup device is in a falling state. When the change in acceleration is not caused by a fall, or when the change in acceleration was caused by a fall but the fall is ended, the image pickup device can quickly return the HDD 30 to the active state. It is therefore possible to properly protect the hard disk of the HDD 30, and to surely take a desired scene.

In addition, even while the HDD 30 is set in the idle state by the automatic power-off function, the image pickup device monitors for a change in acceleration in the image pickup device. When a change in acceleration has occurred in the image pickup device, the image pickup device determines whether the image pickup device is in a falling state. When the change in acceleration is not caused by a fall, or when the change in acceleration was caused by a fall but the fall is ended, the image pickup device can quickly return the HDD 30 to the active state. When the image pickup device determines that the image pickup device is in a falling state, the idle state is maintained. Thus, also in this case, it is possible to properly protect the hard disk of the HDD 30, and to surely take a desired scene.

### [Concrete Example of Fall Determination Process]

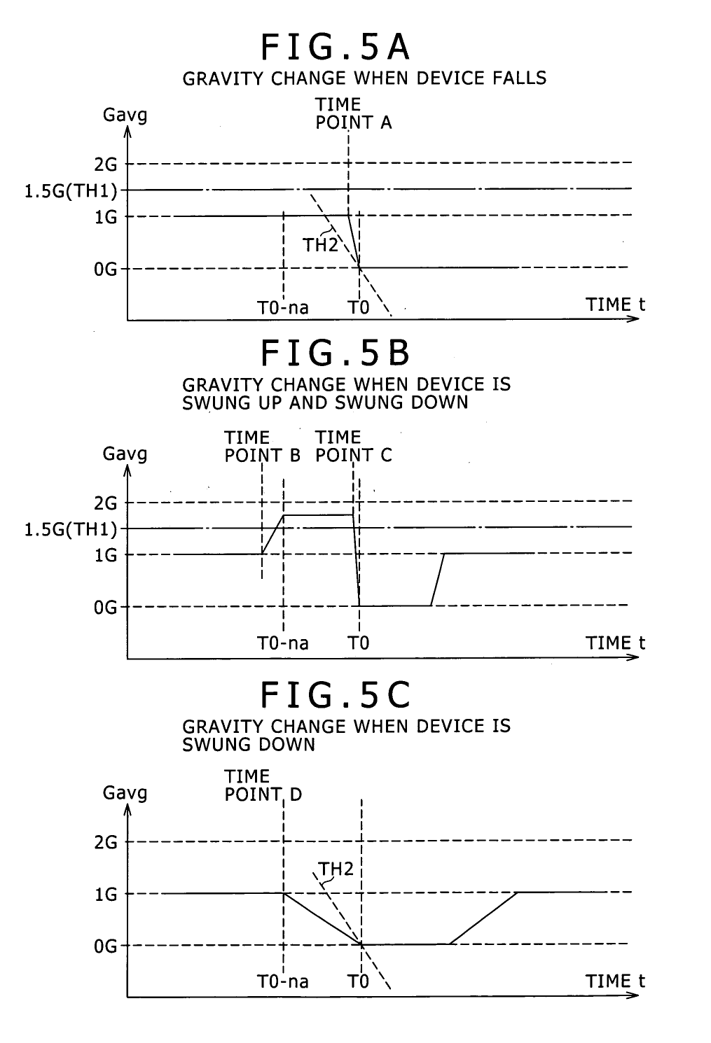

Description will next be made of a concrete example of the fall determination process performed in step S9 in FIG. 3 and in step S20 in FIG. 4. FIGS. 5A, 5B, and 5C are diagrams of assistance in explaining an example of the fall determination process performed in the image pickup device according to the present embodiment.

FIG. 5A is a diagram showing change in gravitational acceleration in the image pickup device when the image pickup device falls from the top of a table or the like. FIG. 5B is a diagram showing change in gravitational acceleration in the image pickup device when the image pickup device is raised and lowered (swung up and swung down) while held in a hand of the user. FIG. 5C is a diagram showing change in gravitational acceleration in the image pickup device when the image pickup device is swung down while held in a hand of the user. I.

each of FIGS. 5A, 5B, and 5C, an axis of abscissas indicates time T, and an axis of ordinates indicates gravitational acceleration, or a synthetic value (Gavg) of acceleration in the present embodiment.

Suppose that the image pickup device according to the present embodiment is placed at an edge of the top of a table. In such a case, consideration will be given to a case where the image pickup device falls from the table when a person hits the table, for example. FIG. 5A shows change in gravitational acceleration applied to the image pickup device in such a case. In this case, until time point A in FIG. 5A, the image pickup device is on the table and no change in acceleration has occurred.

However, a person hits the table, whereby the image pickup device falls from the table and a change in acceleration occurs. The image pickup device comes into a state of weightlessness (gravitational acceleration is “zero”) at a certain time point (time point T0 in FIG. 5A). Accordingly, it is determined that there is a possibility of the image pickup device falling when the image pickup device comes into the state of weightlessness.

However, it cannot be determined that the image pickup device is falling by merely determining that the image pickup device is in the state of weightlessness. This is because the image pickup device can come into the state of weightlessness when the image pickup device is held in a hand of the user and swung, for example. Accordingly, a history of gravitational acceleration from a time point at which the image pickup device comes into the state of weightlessness to a time point preceding the above time point by a predetermined time (T0-na) (from time point (T0-na) to T0) is checked. Incidentally, in FIGS. 5A, 5B, and 5C, “a” in T0-na denotes time intervals of acceleration measurement, and “n” denotes the number of samples.

Specifically, as shown in FIG. 5A, in the case of the image pickup device falling from the table, before a change in acceleration occurs (before time point A in FIG. 5A), the image pickup device is on the table, and thus no change in acceleration occurs. Consideration will be given to a case where, on the other hand, as shown in FIG. 5B, the image pickup device comes into the state of weightlessness as a result of the user holding the image pickup device in a hand of the user and swinging up the image pickup device at time point B and swinging down the image pickup device at time point C.

In this case, as shown in FIG. 5B, a great force exceeding a predetermined threshold value TH1 (1.5 G in FIG. 5B) is applied to the image pickup device during a period from a time point before the image pickup device comes into the state of weightlessness (T0-na) to time point T0, thus indicating that the image pickup device is swung up by the user.

Thus, when the image pickup device comes into the state of weightlessness (0 G) but the application of a greater force than the predetermined threshold value is detected during the predetermined period immediately before the image pickup device comes into the state of weightlessness, it can be determined that the image pickup device is not in a falling state.

There is not only a case where the image pickup device is swung up but also a case where the user for example holds the image pickup device in a hand of the user and swings down the image pickup device without swinging up the image pickup device. However, when the user holds the image pickup device in a hand of the user and swings down the image pickup device, it takes longer for the image pickup device to come into the state of weightlessness than in the case of a free fall. That is, as shown in FIG. 5C, when the image pickup device held in a hand of the user is swung down by the user at time point D, it generally takes time for the image pickup device to come into the state of weightlessness because the image pickup device is held in the hand of the user.

Accordingly, an amount of change in a synthetic value of acceleration (Gavg) per unit time (synthetic value (Gavg)/unit time (ΔT)) and a predetermined threshold value TH2 are compared with each other. In this case, the threshold value TH2 is the slope of the threshold value TH2 represented by a dotted line in FIG. 5C. Thus, when the amount of change in the synthetic value of acceleration (Gavg) per unit time (Gavg/ΔT) is smaller than the threshold value TH2, it can be determined that the image pickup device does not fall freely but is moved by the user.

Therefore, as described above, first, (1) whether the image pickup device is in the state of weightlessness is determined on the basis of the synthetic value of acceleration, and when the image pickup device is in the state of weightlessness, (2) whether a greater force than a predetermined threshold value was applied in the past is determined on the basis of past synthetic values of acceleration. When the greater force was not applied in the past, (3) whether a time of transition to the state of weightlessness is shorter than a predetermined threshold value is determined, and when the time of transition to the state of weightlessness is shorter than the predetermined threshold value, it is determined that the image pickup device is in a falling state. Incidentally, the determination of (3) is made on the basis of the amount of change in the synthetic value of acceleration per unit time, as described above.

In other words, even when a change in acceleration occurs in (1), it can be determined that the image pickup device is not in a falling state when the image pickup device has not come into the state of weightlessness (0 G). In addition, even in a case where it is determined that the image pickup device has come into the state of weightlessness, it can be determined that the image pickup device is not in a falling state when a great force is applied during a certain period immediately before the image pickup device comes into the state of weightlessness in (2), and it can be determined that the image pickup device is not in a falling state when the time of transition to the state of weightlessness is longer than the predetermined threshold value (when the amount of change in the synthetic value of acceleration per unit time is smaller than a threshold value) in (3).

By thus making determination in three stages of (1) to (3), it is possible not to determine that the image pickup device according to the present embodiment is in a falling state even when the image pickup device is lifted or swung by the user. That is, only a free fall of the image pickup device can be detected as the falling state.

As described above, when the image pickup device according to the present embodiment is truly in the falling state (free fall), the image pickup device can maintain the idle state of the HDD 30 to protect the hard disk of the HDD 30 from an impact of the fall. In addition, when a change in acceleration occurs in the image pickup device but the change in acceleration is not caused by a fall, the HDD 30 is restored to the active state, and the image pickup device is quickly restored to a state of being able to receive an operation input from the user so that a process can be performed according to an instruction of the user.

Incidentally, the method of fall detection described with reference to FIGS. 5A, 5B, and 5C is described in detail in Japanese Patent Laid-Open No. 2007-87469, whose application was filed in the past by the applicant of the present application and is already laid open.

### [Others]

Incidentally, in the foregoing embodiment, the idle state has been described as a state in which the hard disk is rotation-driven, and while the position of the magnetic head is maintained on the hard disk, the magnetic head is in an off-track state without being controlled by the servo circuit. When the protection of the hard disk is considered, however, the magnetic head is desirably not on the hard disk. Accordingly, the idle state may include a case where the magnetic head is retained at a predetermined position outside the hard disk rather than simply being maintained on the hard disk in the off-track state.

Of course, even when the idle state is a case where the magnetic head is maintained on the hard disk in the off-track state, the file system itself of the hard disk is not crashed, and therefore a situation in which the hard disk drive becomes unusable can be prevented.

In addition, while the foregoing embodiment has been described by taking as an example a case where the present invention is applied to an image pickup device including a hard disk drive using a hard disk as a recording medium, the present invention is not limited to this. The present invention is applicable to various recording devices using disk recording media such as magneto-optical disks, optical disks and the like. In this case, the head section is a part including an optical pickup and the like.

In addition, the present invention is applicable not only to image pickup devices but also to sound recording devices using a disk recording medium as a recording medium as well as information processing devices having a recording function such as personal computers including a hard disk, and the like.

In addition, in the foregoing embodiment, as described above with reference to FIGS. 5A, 5B, and 5C, whether the image pickup device is in a falling state is determined using acceleration, a synthetic value of acceleration, and history information on these values. As the threshold values used in this case as TH1 and TH2, appropriate values can be used according to a general use mode or the like.

In addition, different threshold values can be used in the falling state determination process of step S9 in FIG. 3 and the falling state determination process of step S20 in FIG. 4. For example, in the falling state determination process of step S9 in FIG. 3, a range in which it is determined that the image pickup device is in a falling state can be widened to provide greater protection for the hard disk, whereas in the falling state determination process in FIG. 4, a range in which it is determined that the image pickup device is in a falling state can be narrowed to give priority to quick change to the active state.

In addition, the falling state determination processes are not limited to the above-described method, but various methods can be used. For example, it is possible to determine whether the image pickup device is in a falling state on the basis of temporal change in detected acceleration. Specifically, as a simple method, it is determined that the image pickup device is falling (free fall) when a change in acceleration per unit time is greater than a predetermined value, as described above. On the other hand, when the change in acceleration per unit time is smaller than the predetermined value, it is determined that the image pickup device is moved by the user rather than falling.

It is thereby possible to determine whether the device is in a falling state relatively accurately and simply. Of course, it is possible to determine whether the image pickup device is falling more accurately by considering also history information on acceleration in the past.

It should be understood by those skilled in the art that various modifications, combinations, sub-combinations and alterations may occur depending on design requirements and other factors insofar as they are within the scope of the appended claims or the equivalents thereof.

What is claimed is:

1. A recording device comprising:
medium drive means for rotation-driving a disk recording medium, and writing data to the disk recording medium through a head section;
determining means for determining whether the recording device is in a falling state when the medium drive means is in an idle state in which state the disk recording medium is rotation-driven and the head section is off a track; and
controlling means for further making determination as to the falling state by the determining means when the determining means determines that the recording device is in the falling state, and when the determining means determines that the recording device is not in the falling state, controlling the medium drive means so as to set the medium drive means in an active state in which state the disk recording medium is rotation-driven to be in an accessible state and the head section is on track.

2. The recording device according to claim 1, further comprising:
acceleration detecting means; and
state controlling means for controlling the medium drive means so as to set the medium drive means in the idle state when the acceleration detecting means detects that an acceleration has occurred in the recording device while the medium drive means is in the active state;
wherein the determining means determines whether the recording device is in the falling state after the state controlling means changes the medium drive means from the active state to the idle state.

3. The recording device according to claim 1, further comprising:
counter means for measuring an elapsed time from a time point at which the medium drive means is set in the active state;
acceleration detecting means; and
state controlling means for controlling the medium drive means so as to set the medium drive means in the idle state when no operation input is received from a user before a count value of the counter means becomes a predetermined value after the medium drive means is set in the active state;
wherein the determining means determines whether the recording device is in the falling state when the acceleration detecting means detects that an acceleration has occurred in the recording device after the state controlling means changes the medium drive means from the active state to the idle state.

4. The recording device according to claim 1, further comprising:
acceleration detecting means; and
storing means for retaining history information based on detection information of the acceleration detecting means;
wherein the determining means determines whether the recording device is in the falling state on a basis of the detection information of the acceleration detecting means and the history information stored by the storing means.

5. The recording device according to claim 1, further comprising:
image pickup means for capturing an image of a subject as an image signal, the image being formed on an image forming surface through a lens;
wherein the recording device functions as an image pickup device for recording the image signal captured through the image pickup means onto the disk recording medium of the medium drive means.

6. A method of controlling a driving state of medium drive means in a recording device, the method comprising:
a determining step of determining whether the recording device is in a falling state by determining means when medium drive means for rotation-driving a disk recording medium and writing data to the disk recording medium through a head section is in an idle state in which state the disk recording medium is rotation-driven and the head section is off a track; and
a controlling step of repeating a process of the determining step when the determining step determines that the recording device is in the falling state, and when the determining step determines that the recording device is not in the falling state, controlling means controlling the medium drive means so as to set the medium drive means in an active state in which state the disk recording medium is rotation-driven to be in an accessible state and the head section is on track.

7. The method of controlling a driving state of medium drive means in a recording device according to claim 6, the method further comprising:
a state controlling step of state controlling means controlling the medium drive means so as to set the medium drive means in the idle state when acceleration detecting means detects that an acceleration has occurred in the recording device while the medium drive means is in the active state;
wherein the determining step is performed to determine whether the recording device is in the falling state after the medium drive means is changed from the active state to the idle state in the state controlling step.

8. The method of controlling a driving state of medium drive means in a recording device according to claim 6, the method further comprising:
a time measurement starting step of counter means starting measuring an elapsed time from a time point at which the medium drive means is set in the active state; and
a state controlling step of state controlling means controlling the medium drive means so as to set the medium drive means in the idle state when no operation input is received from a user before a count value of the counter means whose measurement is started in the time measurement starting step becomes a predetermined value after the medium drive means is set in the active state;
wherein the determining step is performed to determine whether the recording device is in the falling state when acceleration detecting means detects that an acceleration has occurred in the recording device after the medium drive means is changed from the active state to the idle state in the state controlling step.

9. The method of controlling a driving state of medium drive means in a recording device according to claim 6, the method further comprising:
an acceleration detecting step of detecting an acceleration occurring in the recording device by acceleration detecting means; and
a history recording step of recording history information based on detection information in the acceleration detecting step onto storing means;
wherein the determining step determines whether the recording device is in the falling state on a basis of the detection information in the acceleration detecting step and the history information stored by the storing means.

10. A recording device comprising:
a medium drive section configured to rotation-drive a disk recording medium, and write data to the disk recording medium through a head section;
a determining section configured to determine whether the recording device is in a falling state when the medium drive section is in an idle state in which state the disk recording medium is rotation-driven and the head section is off a track; and
a controlling section configured to further make determination as to the falling state by the determining section when the determining section determines that the recording device is in the falling state, and when the determining section determines that the recording device is not in the falling state, controlling the medium drive section so as to set the medium drive section in an active state in which state the disk recording medium is rotation-driven to be in an accessible state and the head section is on track.
